(19) United States
(12) Patent Application Publication
(10) Pub. No.: US 2018/0363893 A1
(43) Pub. Date: Dec. 20, 2018

(54) THERMAL CONDUCTIVE FLEXIBLE PCB AND ALL PLASTIC HEAT SINK FOR LED BULB RETROFIT

(71) Applicant: SABIC Global Technologies B.V., Bergen op Zoom (NL)

(72) Inventors: Yingjun CHENG, Shanghai (CN); Guangde HUANG, Shanghai (CN); Ke JIANG, Shanghai (CN); Jian YANG, Shanghai (CN); Fei SHEN, Shanghai (CN)

(21) Appl. No.: 16/062,213

(22) PCT Filed: Dec. 21, 2016
(86) PCT No.: PCT/IB2016/057893

§ 371 Date: Jun. 14, 2018

Related U.S. Application Data
(60) Provisional application No. 62/270,313, filed on Dec. 21, 2015.

(51) Int. Cl. F21V 29/87; F21V 29/83; F21V 29/74; F21K 9/232

(52) U.S. Cl. CPC F21V 29/87; F21V 29/83; F21Y 2115/10; F21K 9/232; F21V 29/74

(57) ABSTRACT

An illumination device, comprising: a polymeric heat sink having a protrusion extending outward from the polymeric heat sink; a first printed circuit board having at least first and second surfaces opposing one another and being separated by a thickness of the printed circuit board, the first surface of the first printed circuit board supporting at least two light emitting diodes, the second surface of the first printed circuit board conforming to and being thermally coupled to the protrusion of the polymeric heat sink; a radiation-transmissive enclosure configured to at least partially enclose the first printed circuit board and the at least two light emitting diodes; a conductive path placing a light emitting diode into electrical communication with the environment exterior to the device.

### TECHNICAL FIELD

The present application relates to the field of light-emitting diode (LED) illumination devices for use in industrial and residential applications.

### BACKGROUND

Because of the reduced energy consumption and reduced environmental effects, LED devices are a popular alternative to traditional illumination devices, such as incandescent light bulbs and even fluorescent lighting. But because of the relatively high cost of LED devices and because the heat from LED elements may lead to cracking at material interfaces (e.g., between aluminum and plastic) within illumination devices, there is a need in the art for LED devices with improved heat handling characteristics.

### SUMMARY

In meeting the described needs, the present disclosure first provides illumination devices, comprising: a polymeric heat sink having a protrusion extending outward from the polymeric heat sink; a first printed circuit board having at least first and second surfaces opposing one another and being separated by a thickness of the printed circuit board, the first surface of the first printed circuit board supporting at least two light emitting diodes, the second surface of the first printed circuit board conforming to and being thermally coupled to the protrusion of the polymeric heat sink; a radiation-transmissive enclosure configured to at least partially enclose the first printed circuit board and the at least two light emitting diodes; and a conductive path placing a light emitting diode into electrical communication with the environment exterior to the device.

Also provided are methods, comprising: supplying sufficient electricity to an illumination device according to any of the aspects disclosed herein so as to effect illumination from the device.

Additionally provided are illumination devices, comprising: a single-piece polymeric heat sink; a first printed circuit board having at least first and second surfaces opposing one another and being separated by a thickness of the printed circuit board, the first surface of the first printed circuit board supporting a plurality of light emitting diodes, and the second surface of the first printed circuit board being thermally coupled to the protrusion of the polymeric heat sink.

Further disclosed are illumination devices, comprising: a single-piece polymeric heat sink having a protrusion extending therefrom; the protrusion supporting at least two light-emitting diodes thermally coupled to the heat sink; a radiation-transmissive enclosure configured to at least partially enclose the at least two light emitting diodes; and a conductive path placing a light emitting diode into electrical communication with the environment exterior to the device.

### BRIEF DESCRIPTION OF THE DRAWINGS

The summary, as well as the following detailed description, is further understood when read in conjunction with the appended drawings. For the purpose of illustrating the invention, there are shown in the drawings exemplary and preferred embodiments of the invention; however, the disclosure is not limited to the specific methods, compositions, and devices disclosed. In addition, the drawings are not necessarily drawn to scale. In the drawings:

FIG. 1 depicts an illustrative device according to the present disclosure. As shown in the figure, a device may comprise an enclosure (lighting bulb) that encloses one or more LED chips that are supported by a 3D printed circuit board (PCB). In this figure, the PCB is pyramidal/conical in shape, although PCBs are not limited to this particular configuration.

The PCB in turn is thermally coupled to a polymeric (plastic) heat sink that itself comprises a protrusion. As described elsewhere herein, the heat sink may comprise thermoplastic or thermoset polymers. The device may also include a plug (E27; a standard screw base part) or other element used to engage with a power supply for the LEDs. Not shown in

FIG. 1 is a conductive path that places one or more LEDs into electronic communication with the environment exterior to the device.

FIG. 2 depicts a cross-sectional view of a benchmark LED design that uses a bendable PCB formed into a cylindrical shape. As shown in that figure, a PCB supported various LEDs is coupled to a cylindrical, straight-wall heat sink.

FIG. 3 depicts an exterior view of the exemplary device according to FIG. 1.

FIG. 4 depicts a cutaway view of a traditional LED device that features LEDs mounted on a flat PCB that is in turn atop a flat-topped heat sink.

FIG. 5 provides a computer-generated heat profile model, using the conditions described elsewhere herein, for a device according to FIG. 1. (For clarity, dashed lines show which certain regions of the article correspond to certain of the temperatures in the temperature range.)

FIG. 6 provides a computer-generated heat profile model, using the conditions described elsewhere herein, for a device according to FIG. 2. (For clarity, dashed lines show which certain regions of the article correspond to certain of the temperatures in the temperature range.)

FIG. 7 provides a computer-generated heat profile model, using the conditions described elsewhere herein, for a device according to FIG. 3. (For clarity, dashed lines show which certain regions of the article correspond to certain of the temperatures in the temperature range.)

FIGS. 8-10 show the beam angle of the various devices shown in FIGS. 1-3, respectively. (Beam angle describes the light dispersion performance for luminaires, and is defined as the angle between the two directions opposed to each other over the beam axis for which the luminous intensity is half that of the maximum luminous intensity.)

FIG. 11 illustrates an exemplary device according to the present disclosure, which device features a polymeric heat sink having channels (e.g., for heat exchanged) formed therein.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Any documents mentioned herein are incorporated herein in their entireties for any and all purposes.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. When referring to a value, the term “about” means the value and all other values within 10% of the value. For example, “about 10” means from 9 to 11 and all intermediate values, including 10.

Aspect 1. An illumination device, comprising: a polymeric heat sink having a protrusion extending outward from the polymeric heat sink; a first printed circuit board having at least first and second surfaces opposing one another and being separated by a thickness of the printed circuit board, the first surface of the first printed circuit board supporting at least two light emitting diodes, the second surface of the first printed circuit board conforming to and being thermally coupled to the protrusion of the polymeric heat sink; a radiation-transmissive enclosure configured to at least partially enclose the first printed circuit board and the at least two light emitting diodes; a conductive path placing a light emitting diode into electrical communication with the environment exterior to the device.

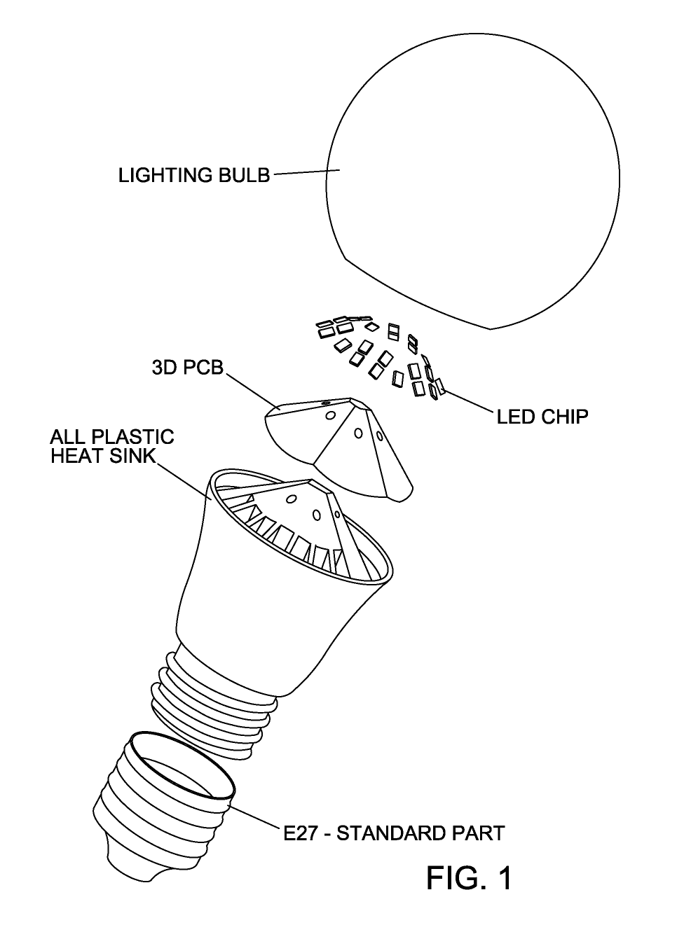

FIG. 1 illustrates an exemplary device according to the present disclosure. As shown in that figure, a device may include a heat sink (suitably polymeric, also suitable formed of a single piece). A 3-D PCB (e.g., a bendable PCB) suitably surmounts a protrusion of the heat sink, as shown in FIG. 1, which shows a heat sink having a pyramidal protrustion. LED chips are suitably supported by the PCB. An enclosure (e.g., lighting bulb) is suitably installed so as to engage with the heat sink and enclose the LED chips. A device may also include a fitting, which fitting serves to connect the device to a power source.

Polymeric heat sinks are described in additional detail elsewhere herein. A printed circuit board (PCB) may be rigid or flexible. Flexible PCBs are considered particularly suitable, as they may be manufactured in a planar configuration and then bent, folded, or otherwise shaped to achieve a desired final conformation. A PCB may include score lines, grooves, perforations, or other features to facilitate folding or other shaping processes. A PCB may be formed with one or more rigid regions that are connected by flexible regions; the rigid and flexible regions need not be made of the same material.

A PCB may be resiliently bendable such that it may be bent and then returned to its original form when released. A PCB may also be bendable such that it retains a particular form when bent into that form.

As described above, the first and second surfaces of the PCB are suitably separated by a thickness of the PCB. A thickness may be from, e.g., about 0.1 to about 5 or 10 mm, or from about 0.2 to about 2 mm, or even about 1 mm.

Printed circuit boards are well-known to those of skill in the art and may comprise a variety of materials, e.g., silicon, copper (or other metals), and other insulating, semi-conducting, and conducting materials. A PCB may include other electronic elements in addition to LEDs, e.g., processors, convertors, transistors, and the like.

Light emitting diodes (LEDs) supported by the PCBs are known to those of skill in the art. A LED may be configured to emit white, red, blue, green, purple, or other colored light. A device may include LEDs configured to emit light of different colors, e.g., white LEDs and blue LEDs. The first (outer, in some embodiments) surface of the PCB suitably supports one or more LEDs.

The second (inner, in some embodiments) surface of the PCB suitably faces the heat sink and the interior of the illumination device. The second surface may face or otherwise overlie the protrusion of the heat sink; as one example, the second surface of the PCB is shaped to conform to the heat sink's protrusion. The second surface of the PCB (and the PCB, in general) is suitably in thermal communication with the heat sink. This may be accomplished by direct physical contact, but may also be accomplished by contact (or communication) via a thermally conductive material, such as a thermal paste, a thermal grease, a thermally conductive tape, and the like.

Radiation-transmissive enclosures may be glass, polymeric, ceramic, or some combination thereof The enclosure may be fully transparent to visible light, but may also be translucent to light. In some embodiments, the enclosure may act as a diffuser, but it may also act as a concentrator or even as a lens for illumination generated by the LEDs of the device.

An enclosure may be spherical, ovoid, tubular, conical, frustoconical, cuboid, rectangular, other otherwise polygonal. An enclosure may include one or more heat exchange features, which features are described elsewhere herein. Suitable enclosures may be made by, e.g., injection molding, injection blow molding, injection stretch blow molding, or other processes known to those of skill in the art. Spherical enclosures are considered especially suitable, but are not required.

A device may also include one or more reflectors. Such reflectors may be disposed within the enclosure, e.g., so as to disperse or otherwise redirect illumination from the LEDs of the device. Reflectors may also be disposed outside of the enclosure. The enclosure may itself be reflective.

Aspect 2. The illumination device of aspect 1, wherein the first printed circuit board comprises at least two facets, each facet having first and second surfaces opposing one another and being separated by a thickness of the printed circuit board facet, each facet supporting one or more light emitting diodes lying on a line that is within 5 degrees of parallel to the protrusion of the polymeric heat sink, and the second surface of each facet being thermally coupled to the protrusion of the polymeric heat sink.

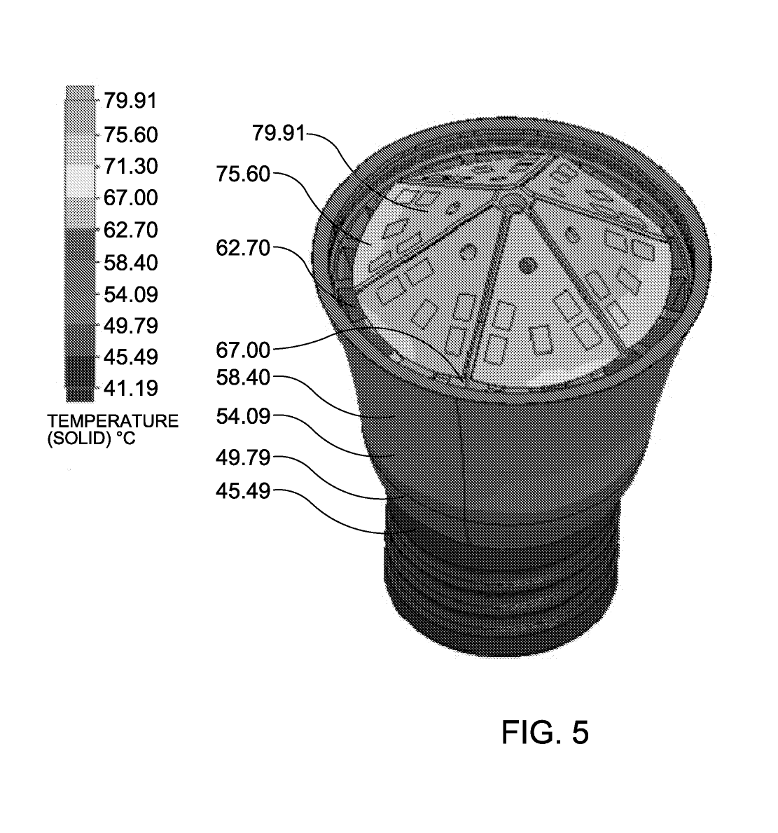

A faceted PCB is shown in FIG. 5. As shown in that FIG., a PCB according to the present disclosure may include 6 facets. PCBs having 2, 3, 4, 5, 6, 7, 8 ,9, 10, or even more facets are considered suitable. The facets of a PCB may be identical (e.g., in shape, area, LED configuration) to one another, but a PCB may include 2 or more facets that differ from one another in some respect.

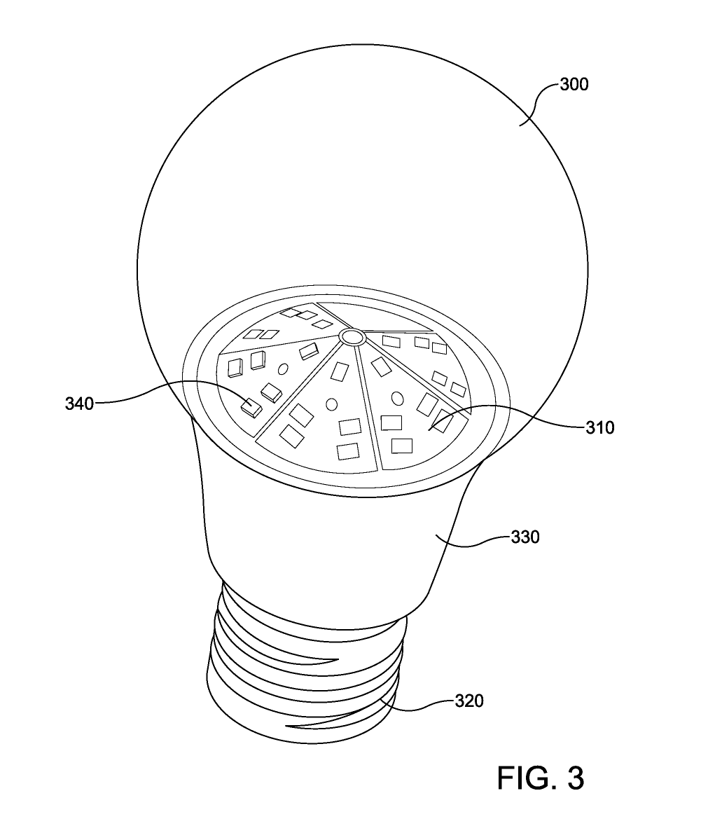

Aspect 3. The illumination device of aspect 2, wherein the protrusion comprises one or more facets complementary to one or more facets of the first printed circuit board. FIG. 1 and FIG. 3 depict such an embodiment; as shown in those FIGs., an all plastic heat sink features a pyramidal protrusion that includes one or more facets that are complementary to one or more facets of the 3D PCB shown in that figure. In this way, a device may feature a close fit between the PCB and the heat sink.

As shown in FIG. 3, a device according to the present disclosure may include a fitting 320 (e.g., a screw-in conductor) that connects the device to an external power source. The fitting is suitably engaged with heat sink 330; the features of suitable heat sinks are described elsewhere herein. The heat sink may include a protrusion (also described elsewhere herein) which protrusion underlies PCB 310. PCB 310 may be a flexible/bendable PCB.

The PCB suitably supports various LEDs 340. The LEDs may be of a single color or of multiple colors. LEDs may also differ in shape, size, or other features. An enclosure 300 is suitably disposed to as to enclose PCB 310 and LEDs 340.

Aspect 4. The illumination device of aspect 1, wherein the protrusion is characterized as being conical, frustoconical, spherical, partially spherical, or tapered. (e.g., hemispherical). A conical protrusion is shown in FIG. 1. A protrusion need not be a circular, conical structure, as a protrusion may be a tapered polygon; e.g., trapezoidal in cross-section, such as a pyramid having the top cut away.

A heat sink protrusion may, in some embodiments, be disposed within a depression or other hollowed region of a heat sink. As one example, a heat sink may include a dished-in portion, from which dished-in portion the protrusion extends.

A protrusion may have one or more surfaces that is inclined by from about 0 to about 90 degrees, or from about 3 to about 87 degrees, or from about 6 to about 84 degrees, or from about 9 to about 81 degrees, or from about 12 to about 78 degrees, or from about 15 to about 84 degrees, or from about 18 to about 81 degrees, or from about 21 to about 78 degrees, or from about 24 to about 75 degrees, or from about 27 to about 72 degrees, or from about 30 to about 69 degrees, or from about 33 to about 66 degrees, or from about 39 to about 63 degrees, or from about 42 to about 60 degrees, or from about 45 to about 57 degrees, or from about 48 to about 54 degrees, or about 50 degrees from the vertical.

A conical protrusion may be used with a faceted PCB. Likewise, a faceted protrusion may be used with a conical PCB. Physical gaps between a PCB and a protrusion may be filled in by a thermally conductive material, e.g., a grease, a metal, a tape, a phase change material, and the like. Suitable such materials are described elsewhere herein.

Aspect 5. The illumination device of aspect 4, wherein the first printed circuit board (PCB) is characterized as being conical, frustoconical, spherical, hemispherical, or tapered. In a preferred embodiment, the first PCB is shaped so as to conform to the heat sink protrusion. It is not a requirement, however, that a PCB conform to the entirety of the protrusion; as one example, a PCB may conform to the upper portion of a conical protrusion but not the lowermost portion.

The PCB, when installed in a device, may have one or more surfaces that is inclined by from about 0 to about 90 degrees, or from about 3 to about 87 degrees, or from about 6 to about 84 degrees, or from about 9 to about 81 degrees, or from about 12 to about 78 degrees, or from about 15 to about 84 degrees, or from about 18 to about 81 degrees, or from about 21 to about 78 degrees, or from about 24 to about 75 degrees, or from about 27 to about 72 degrees, or from about 30 to about 69 degrees, or from about 33 to about 66 degrees, or from about 39 to about 63 degrees, or from about 42 to about 60 degrees, or from about 45 to about 57 degrees, or from about 48 to about 54 degrees, or about 50 degrees from the vertical.

Aspect 6. The illumination device of any of aspects 1-5, wherein the heat sink comprises one or more heat exchange features. The heat sink is suitably exposed to the environment exterior to the illumination device. The device may also include a source of moving fluid (e.g., air) to assist with heat transfer away from the heat sink or the device. The device may also be installed in an assembly (e.g., a lamp or a bank of lamps) that includes a source of moving fluid (e.g., air, liquid) to assist with heat transfer away from the heat sink or the device, e.g., a fluid that is exerted into one or more passages within the heat sink. The heat sink itself may contain one or more fluids.

Aspect 7. The illumination device of aspect 6, wherein a heat exchange feature comprises a fin, a passage, or any combination thereof. Fins may include traditional rectangular-shaped fins as well as any other protrusion, e.g., spikes, ridges, and the like. A heat exchange feature may also include a depression or hollow formed in the heat sink.

Passages—e.g., holes, tunnels, channels, and the like—are also considered suitable heat exchange features. In some embodiments, the heat exchange features are disposed on or in the heat sink so as to minimize the features' visibility to outside observers. For example, a heat sink may include a series of fins or ridges that are not visible behind the illumination device's enclosure when the enclosure is installed.

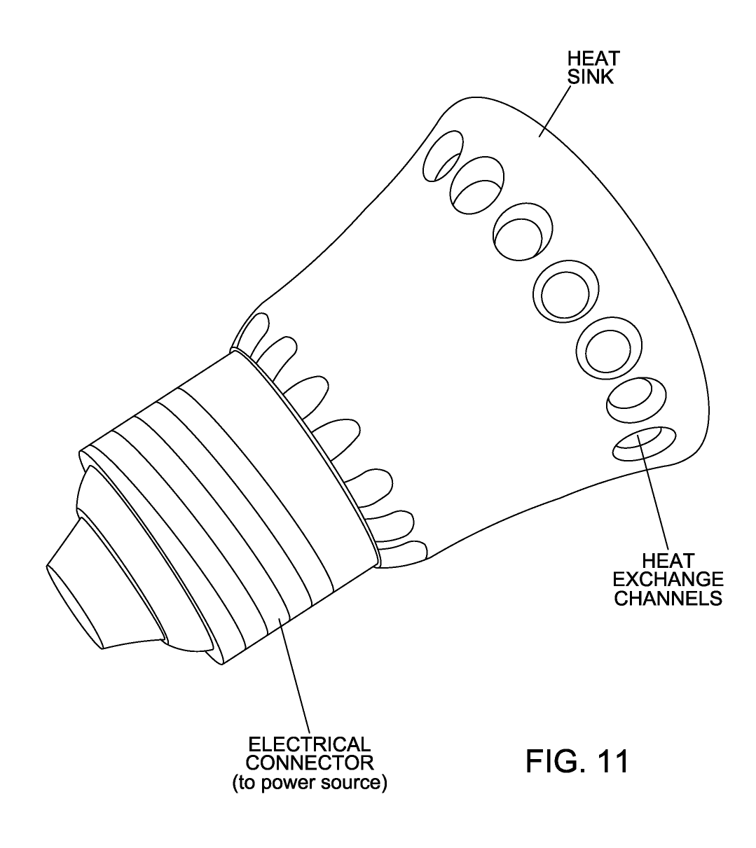

One illustrative such heat sink is shown in FIG. 11. As shown in that figure, a heat sink may include heat exchange channels (which may be formed in the heat sink at the time of manufacture or formed into the heat sink, e.g., via drilling, at a later point in time) that facilitate heat transfer from the heat sink. A heat sink may also include (not shown) fins or other projections to enhance heat transfer.

A passage may extend through part of the heat sink. A passage may have a characteristic cross-sectional dimension (e.g., width, diameter) of from about 0.01 mm to about 1, 2, 3, 4, 5, 6, 7, 8, 9, or even 10 mm. A passage may be circular in cross-section, but this is not a requirement, as a passage may be ovoid or otherwise polygonal in cross section. Passages may be radial, axial, or otherwise oriented. A heat sink may include two or more types of passages.

A fin may extend along a length of the heat sink or along a portion of a length of the heat sink. A fin may have a cross-sectional dimension (e.g., height, width, length) of from about 0.01 mm to about 1, 2, 3, 4, 5, 6, 7, 8, 9, 10, 11, 12, 13, 14, 15, 16, 17, 18, 19, 20, 21, 22, 23, 24, 25 mm, or even greater.

A fin may be formed of the material of the heat sink, but a fin may also be formed of a material that differs from that of the heat sink. A fin may be thermally coupled to the heat sink via a thermally conductive material; thermal coupling is described elsewhere herein.

Aspect 8. The illumination device of any of aspects 1-7, wherein the radiation-transmissive enclosure comprises one or more heat exchange features. Suitable heat exchange features are described elsewhere herein. As with the heat sinks, the heat exchange features may be disposed so as to minimize the features' visibility to outside observers.

Aspect 9. The illumination device of aspect 8, where a heat exchange feature comprises a fin, a passage, or any combination thereof.

Aspect 10. The illumination device of any of aspects 1-9, wherein the polymeric heat sink is characterized as being a single piece. For example, illustrative FIG. 1 shows a heat sink that is formed of a single piece of polymeric (plastic) material. Injection molded heat sinks are considered suitable, as are additive-manufactured heat sinks.

The heat sink may be formed so as to include cavities or other hollows to accommodate power modules, controllers, processors, connectors, and the like. As shown in FIG. 1, a heat sink may be formed so as to engage with an electrical socket connector (E27).

Aspect 11. The illumination device of any of aspects 1-10, wherein the polymeric heat sink comprises polybutylene terephthalate, polyamide, polyphenylene sulfide, polycarbonate, or any combination thereof The foregoing is an illustrative list only, as other polymerical materials (e.g., polyetherimide) are also suitable.

Aspect 12. The illumination device of aspect 11, wherein the polymeric heat sink comprises polyphenylene sulfide (PPS); PPS is considered especially suitable. Heat sinks (of whatever material) made via injection molding processes are considered especially suitable.

Aspect 13. The illumination device of any of aspects 1-12, wherein each of the at least two light emitting diodes lie on one or more lines that are within 5 degrees of a line parallel to the underlying region of the protrusion of the polymeric heat sink.

In some embodiments, an LED may be aligned so that the LED's major axis (i.e., the central axis of the LED or even the peak intensity axis of the light emitted from the LED) lies on a line that is within 5 degrees of normal from the underlying region of the protrusion of the heat sink. In this way, a device may be constructed such that the illumination from the LEDs projects normally from (or nearly normal from) the heat sink's protrusion.

Aspect 14. The illumination device of any of aspects 1-13, further comprising a heat conductive material placing the second surface of the first printed circuit board and the protrusion of the heat sink into thermal communication.

Aspect 15. The illumination device of aspect 14, wherein the heat conductive material comprises a grease, a tape, a phase change material, or any combination thereof. Suitable greases include, e.g., Dow Corning 9184™ and Laird Tgrease 980™. Suitable thermally conductive tapes include, e.g., Sil-Pad 400™ and Gap Pad 1500™. Suitable phase change materials include, for example, Hi-flow 105™ and Hi-Flow 225UT™. The foregoing list is illustrative only and is not limiting.

Aspect 16. The illumination device of any of aspects 1-15, wherein the illumination device is characterized as having a beam angle of at least about 280 degrees, e.g., about 280, about 285, about 287, about 290, about 293, about 296, about 299, about 302, about 305, about 308, about 311, about 314, about 317, about 320, about 323, about 326, about 329, about 332, about 335, about 338, about 341, or even higher. (By beam angle is meant the angle between the two directions opposed to each other over the beam axis for which the luminous intensity is half that of the maximum luminous intensity.) Beam angles above about 300 degrees are considered especially suitable.

Aspect 17. The illumination device of any of aspects 1-15, wherein the illumination device is characterized as having a beam angle of from about 290 degrees to about 330 degrees, e.g., about 290, about 291, about 292, about 293, about 294, about 295, about 296, about 297, about 298, about 299, about 300, about 301, about 302, about 303, about 304, about 305, about 306, about 307, about 308, about 309, about 310, about 311, about 312, about 313, about 314, about 315, about 316, about 317, about 318, about 319, or even about 320 degrees.

A beam angle of about 290-315 (e.g., 310) degrees is considered suitable; existing devices may have a beam angle of only about 120 degrees. Beam angles of between about 120 degrees and about 330 degrees are considered especially suitable.

Aspect 18. The illumination device of any of aspects 1-18, wherein the device further comprises a source of electricity in electronic communication with a fitting that places the illumination device into electronic communication, through the conductive path, with the source of electricity. The source of electricity may be a battery or an electrical line, e.g., a commercial or residential electrical line.

Aspect 19. The illumination device of aspect 18, wherein the device further comprises a heat conductive material disposed so as to place the heat sink into thermal communication with the fitting. Suitable heat conductive materials are described elsewhere herein.

Aspect 20. The illumination device of any of aspects 1-19, wherein the heat sink has an in-plane thermal conductivity of from about 5 to about 20 W/m*K, e.g., about 5, about 6, about 7, about 8, about 9, about 10, about 11, about 12, about 13, about 14, or even about 20 W/m*K. Thermal conductivity may be measured according to, e.g., ASTM W 1461-07.

Aspect 21. The illumination device of any of aspects 1-20, wherein the heat sink has a through-plane thermal conductivity of from about 5 to about 15 W/m*K, e.g., about 5, about 6, about 7, about 8, about 9, about 10, about 11, about 12, about 13, about 14, or even about 20 W/m*K.

Aspect 22. The illumination device of any of aspects 1-21, wherein the illumination device satisfies the Energy Star™ LED criteria (according to the May 13, 2011 revision of “ENERGY STAR® Program Requirements for Integral LED Lamps”; criterion 7A) for omnidirectional LED illumination devices.

That criteria reads, in relevant part, “Products shall have an even distribution of luminous intensity (candelas) within the 0° to 135° zone (vertically axially symmetrical). Luminous intensity at any angle within this zone shall not differ from the mean luminous intensity for the entire 0° to 135° zone by more than 20%. At least 5% of total flux (lumens) must be emitted in the 135° -180° zone. Distribution shall be vertically symmetrical as measured in three vertical planes at 0°, 45°, and 90°.”

Aspect 23. A method, comprising: supplying sufficient electricity to an illumination device according to any of aspects 1-22 so as to effect illumination from the device.

Aspect 24. A method, comprising: assembling a polymeric heat sink, a first printed circuit board, two or more light emitting diodes, a radiation-transmissive enclosure, and a conductive path so as to give rise to a device according to any of aspects 1-22.

Assembly may be performed in a variety of ways, including soldering, press-fitting, adhering, and combinations thereof. In some embodiments, conductive portions may be formed in or on the various components such that one or more components may be hand-assembled together so as to form a conductive path between the two components.

Aspect 25. An illumination device, comprising: a single-piece polymeric heat sink; a first printed circuit board (PCB) having at least first and second surfaces opposing one another and being separated by a thickness of the printed circuit board, the first surface of the first printed circuit board supporting a plurality of light emitting diodes (LEDs), the second surface of the first printed circuit board being thermally coupled to the protrusion of the polymeric heat sink.

Suitable heat sinks, PCBs, and LEDs are described elsewhere herein. Thermal coupling may be accomplished via, e.g., physical contact or via a thermally conductive material. Suitable such materials include thermal greases, thermal tapes, phase change materials, and the like, all of which are described elsewhere herein.

Aspect 26. The illumination device of aspect 25, wherein the device is configured such that when at least some of the plurality of light emitting diodes are illuminated, the device satisfies the Energy Star™ LED criteria (May 13, 2011 revision of “ENERGY STAR® Program Requirements for Integral LED Lamps”; criterion 7A) for omnidirectional LED illumination device, which criteria are described elsewhere herein.

Aspect 27. An illumination device, comprising: a single-piece polymeric heat sink having a protrusion extending therefrom; the protrusion supporting at least two light-emitting diodes thermally coupled to the heat sink; a radiation-transmissive enclosure configured to at least partially enclose the at least two light emitting diodes; a conductive path placing a light emitting diode into electrical communication with the environment exterior to the device.

As described above, one or more LEDs may be supported by the heat sink, as it is not always necessary that a PCB support LEDs. As one example, a user may use a user may use LDS technology that creates a circuit directly on the plastic heat sink, without the need for a separate printed circuit board.

The LEDs may directly contact the heat sink. Alternatively, the LEDs may be thermally coupled to the heat sink via a thermally conductive material, e.g., a thermal grease, a thermal tape, a phase change material, or any combination thereof The heat sink may include one or more recesses into which the LEDs may fit.

Suitable heat sinks, protrusions, LEDs, and enclosures are described elsewhere herein. A heat sink may have disposed thereon two or more LEDs, as well as a conductive path between the LEDs and a power source, a controller, a processor, or any combination thereof

Devices according to this aspect may be configured such that when at least some of the plurality of light emitting diodes are illuminated, the device satisfies the Energy Star™ LED criteria (May 13, 2011 revision of “ENERGY STAR® Program Requirements for Integral LED Lamps”; criterion 7A) for omnidirectional LED illumination device, which criteria are described elsewhere herein.

Devices may also be characterized as having a beam angle of at least about 280 degrees, e.g., about 280, about 285, about 287, about 290, about 293, about 296, about 299, about 302, about 305, about 308, about 311, about 314, about 317, about 320, about 323, about 326, about 329, about 332, about 335, about 338, about 341, or even higher. (By beam angle is meant the angle between the two directions opposed to each other over the beam axis for which the luminous intensity is half that of the maximum luminous intensity.) Beam angles above about 300 degrees are considered especially suitable.

A device may further be characterized as having a beam angle of from about 290 degrees to about 330 degrees, e.g., about 290, about 291, about 292, about 293, about 294, about 295, about 296, about 297, about 298, about 299, about 300, about 301, about 302, about 303, about 304, about 305, about 306, about 307, about 308, about 309, about 310, about 311, about 312, about 313, about 314, about 315, about 316, about 317, about 318, about 319, or even about 320 degrees.

Devices according to any of aspects 1-22 and 25-27 may be used singly or multiply. As one example, a user may construct a lighting panel that includes a plurality of the disclosed devices. A user may also construct a building module (e.g., a ceiling, a wall, a fixture) that includes one or more of the disclosed devices. Modules may be constructed in modular form to enable rapid assembly/disassembly.

Illustrative Data—Temperature

Junction temperature was investigated as a way to indicate thermal performance of LED chips; and FIGS. 5, 6, and 7 depict thermal simulation results for the three different designs in FIGS. 1, 2, and 3, respectively, using the following criteria:

Total lamp wattage: 6.2W

Lighting output: 450 lm

LED numbers: 30 PCS

Thermal conductivity for heat sink:

Through plane=3.4 W/M·K, in plane=2.0 W/M·K

Heat generation: 3.26 W

Conversion of LED power to heat: 70%

Boundary condition: ambient temperature=25 degree C.

No convection

A comparative assessment of optical performance was done using the software program Light Tools™, which assessment was based on the following conditions:

| Variable | Selection |
|---|---|
| Material for bulb | LUX2144G (high diffusive grade) |
| Total flux | 1050 lumen |
| Total ray to trace | 20,000,000 (rays) |
| Optical property for bulb & other | Smooth optical |
| components | |

Under the conditions described above, the disclosed design of FIG. 1 (using an all-plastic heat sink and a 3D PCB layout) had the best comparative thermal performance.

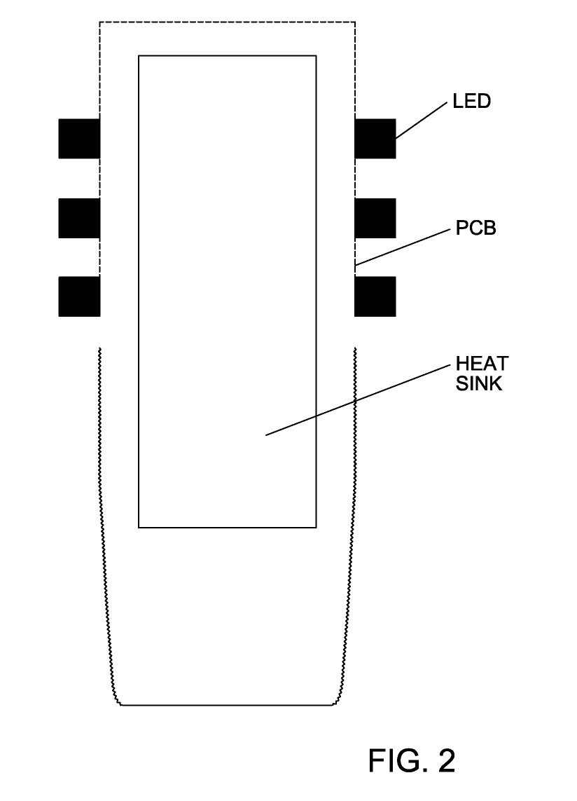

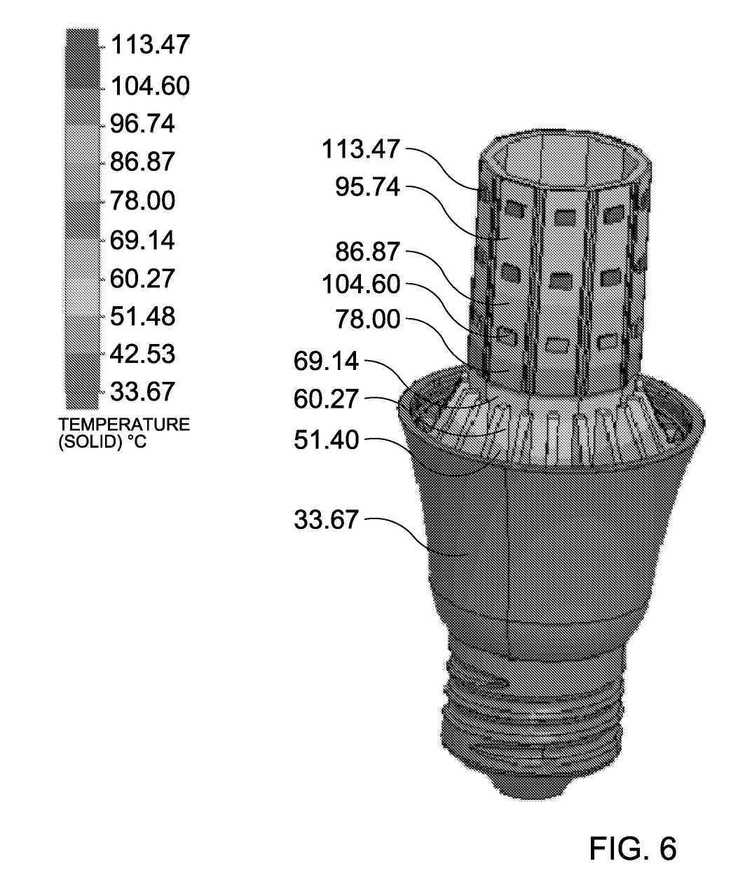

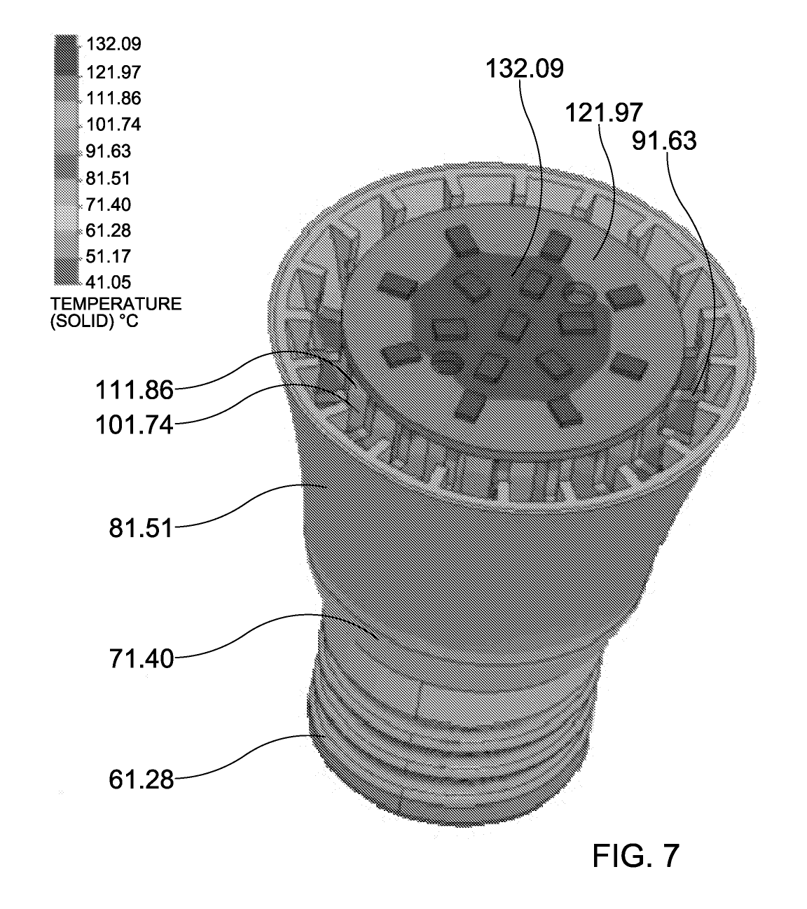

As shown in FIG. 5, the temperature at the PCB was 79.91° C. (lower temperatures are at the bottom fitting of the device; higher temperatures were at the upper portion of the device, where the LEDs are located). The corresponding temperature for the benchmark design of FIGS. 2 and 6 was 113.47° C. (lower temperatures are at the bottom fitting of the device; higher temperatures were at the upper portion of the device, where the LEDs are located), and the corresponding temperature for the traditional design of FIGS. 3 and 7 was 132° C. (lower temperatures are at the bottom fitting of the device; higher temperatures were at the upper portion of the device, where the LEDs are located).

Without being bound to any particular theory, this may be a result of the shorter path from the LED to the outside surface of heat sink in the disclosed designs. Also without being bound to any particular theory, heat energy was transferred by a larger PCB area through to heat sink and finally to the ambient environment.

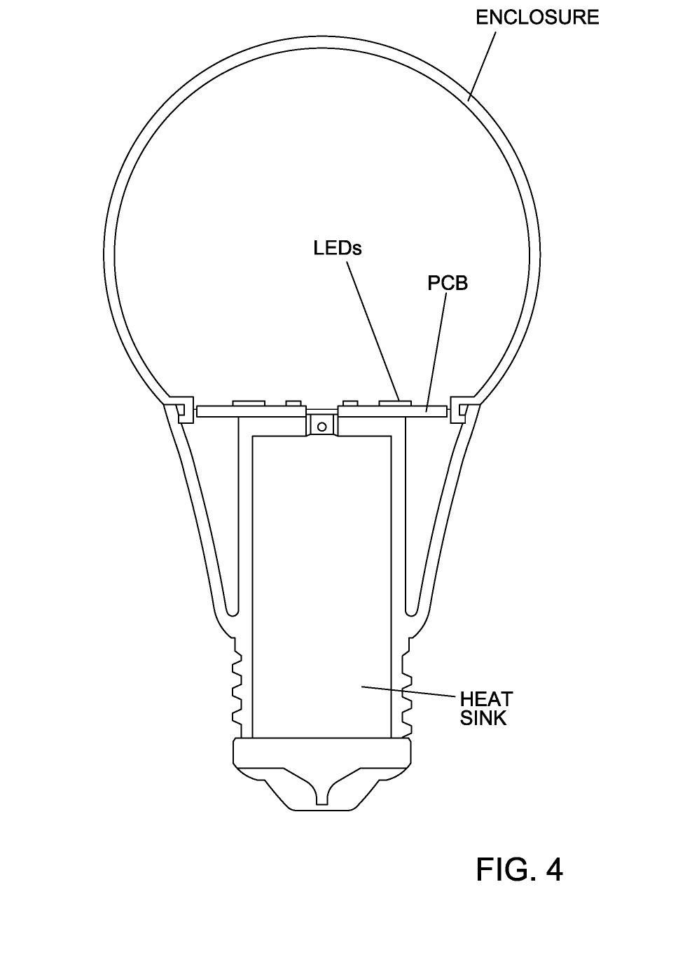

FIG. 7 shows that the heat energy in the device of FIG. 4 was centralized at the cylinder feature of heat sink, which caused a lower temperature on outer surface of heat sink. Again—and without being bound to any particular theory—the comparatively shorter path from the LED to the outside surface of heat sink in the disclosed designs and the comparatively larger transfer area through a larger PCB area through to the heat sink and finally to the ambient environment led to the superior performance described above.

Thus, the disclosed design demonstrated temperatures at the LEDs that were significantly lower than the LED temperatures of the benchmark (cylindrical) and flat PCB designs. A device according to the present disclosure may have an LED temperature that is from about 1% to about 50%, or from about 3% to about 47%, or from about 7% to about 44%, or from about 10% to about 41%, or from about 13% to about 38%, or from about 16% to about 35%, or from about 19% to about 32%, or from about 22% to about 29%, or from about 25% to about 26% the LED temperature of a comparable device (e.g., having comparable number of LEDs, having comparable illumination) using a cylindrical heat sink or a flat heat sink.

Illustrative Data—Beam Angle

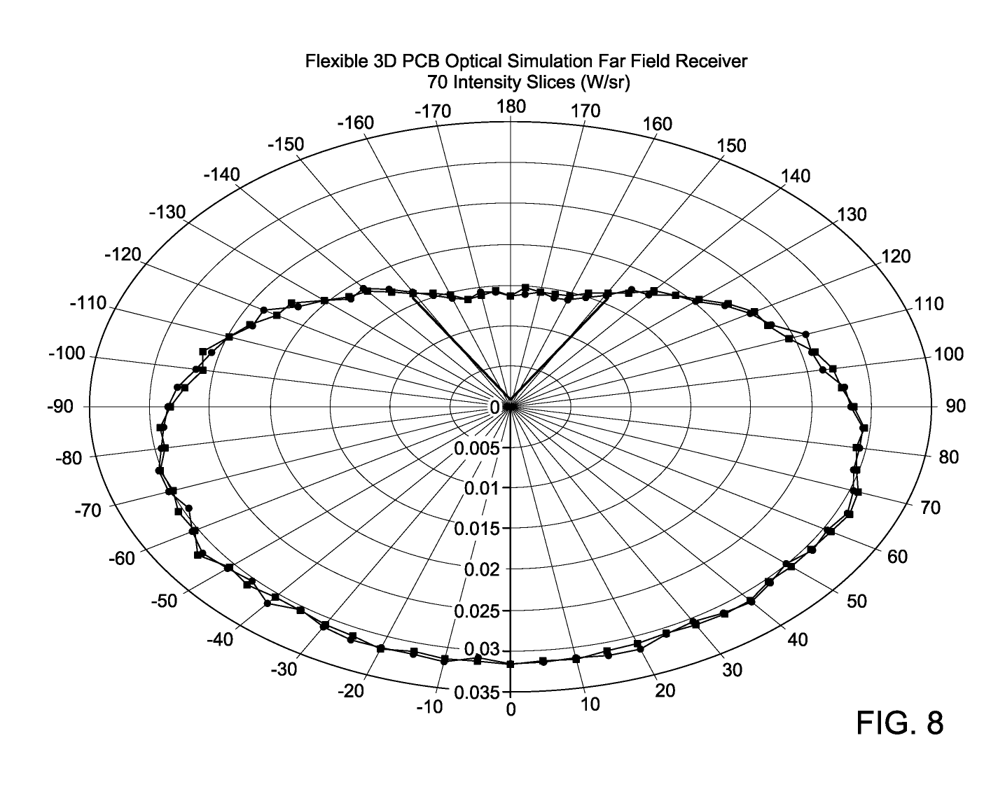

As shown in FIGS. 8, 9, and 10, the disclosed design and the benchmark design showed higher beam angles than the traditional flat PCB approach.

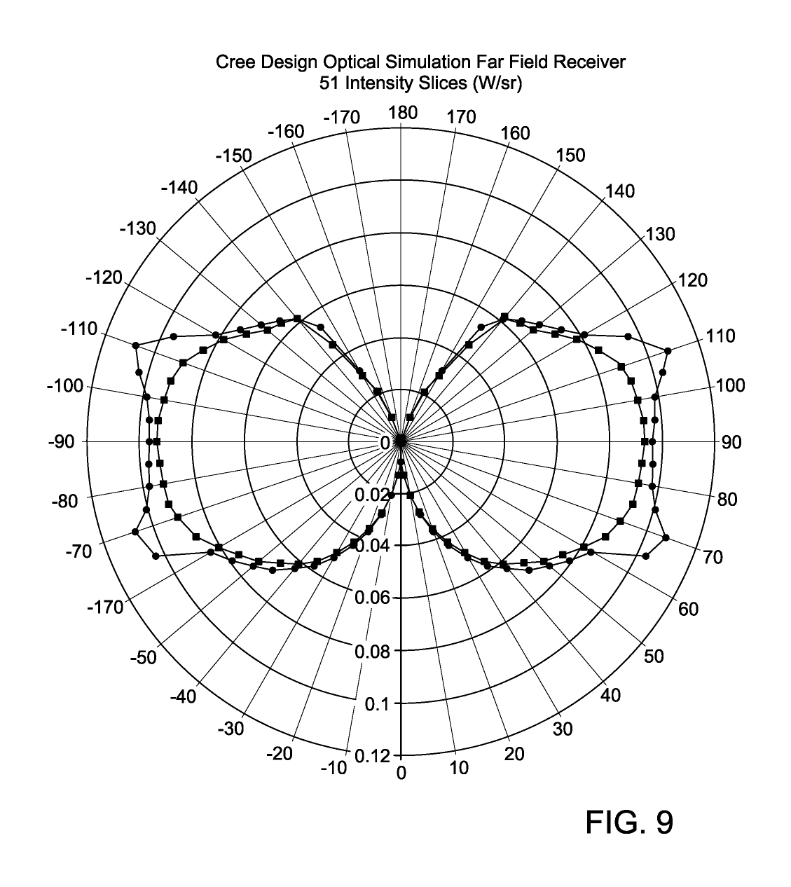

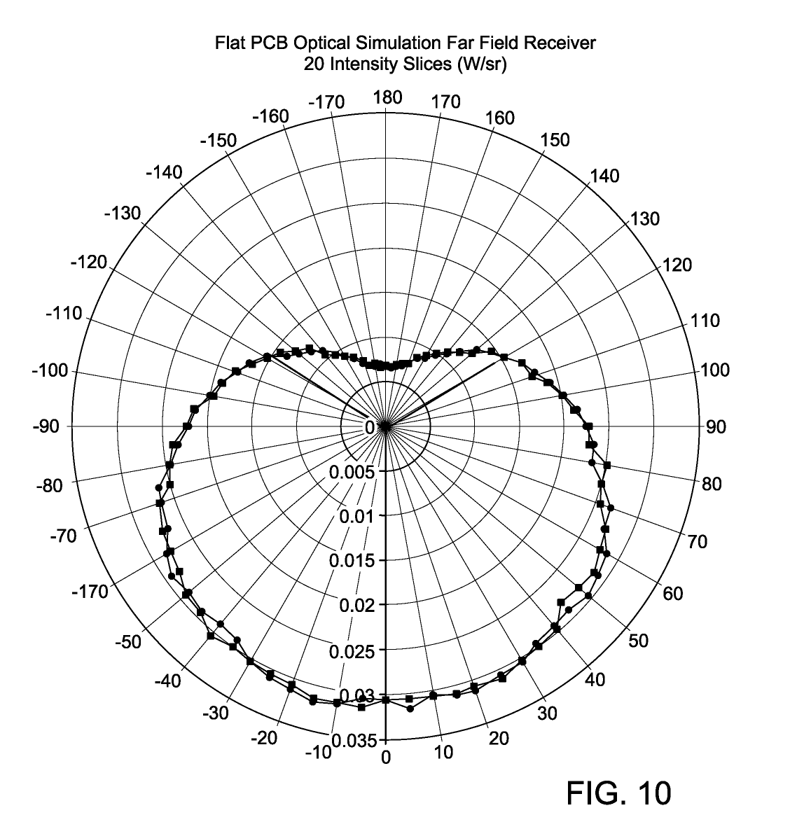

In FIG. 8, the beam angle was about 300 degrees; in FIG. 9 the beam angle was about 327 degrees, and the beam angle in FIG. 10 was about 240 degrees. As described elsewhere herein, only the disclosed design meets Energy Star™ criteria for LED omnidirectional lighting, as only the disclosed design provided the specified level of luminous intensity in the 0-135 degree range.

The present disclosure thus provides, inter alia, a design for LED illuminators that use flexible PCBs and plastic heat sinks; these designs may fulfill the Energy-Star light distribution criteria for a LED bulb retrofit. Compared to traditional solutions that use multiple rigid printed circuit boards (PCBs) that require separate LED soldering, assembling (on a heat sink), and a wire connection process (between PCB and heat sink), the disclosed designs provide a simplified assembly process that reduces or even eliminates the need for one-by-one soldering of LED and wire connections between PCBs. The disclosed technology may be used to retrofit/update existing illumination systems; e.g., as a drop-in solution in which a device made according to the disclosed technology is used to replace an existing such device, e.g., an existing incandescent light bulb or even an existing LED illumination device.

In addition, the use in the present design of flexible PCBs enables a 3D layout of LEDs on a PCB so as to achieve a larger beam angle, which angle offers the same optical performance as a 40 W incandescent lamp. A 3D PCB is one solution to achieve a larger beam angle for the all-plastic design, as an alternative, a user may use LDS technology that creates a circuit directly on the plastic heat sink.

The present disclosure thus represents a unique achievement of improved beam angle and improved temperature performance over existing alternatives. For example, the present disclosure provides devices that satisfy the May 13, 2011 revision of “ENERGY STAR® Program Requirements for Integral LED Lamps” (criterion 7A) while also exhibiting a beam angle of greater than 280 degrees, e.g., from 290 to about 330 degrees.

1. An illumination device, comprising:
a polymeric heat sink having a protrusion extending outward from the polymeric heat sink;
a first printed circuit board having at least first and second surfaces opposing one another and being separated by a thickness of the printed circuit board,
the first surface of the first printed circuit board supporting at least two light emitting diodes, and
the second surface of the first printed circuit board conforming to and being thermally coupled to the protrusion of the polymeric heat sink;
a radiation-transmissive enclosure configured to at least partially enclose the first printed circuit board and the at least two light emitting diodes; and
a conductive path placing a light emitting diode into electrical communication with the and environment exterior to the device.

2. The illumination device of claim 1, wherein the first printed circuit board comprises at least two facets, each facet having first and second surfaces opposing one another and being separated by a thickness of the printed circuit board facet, each facet supporting one or more light emitting diodes lying on a line that is within 5 degrees of parallel to the protrusion of the polymeric heat sink, and the second surface of each facet being thermally coupled to the protrusion of the polymeric heat sink.

3. The illumination device of claim 1, wherein the protrusion is characterized as being conical, frustoconical, spherical, partially spherical, or tapered.

4. The illumination device of claim 1, wherein the first printed circuit board is characterized as being conical, frustoconical, spherical, partially spherical, or tapered.

5. The illumination device of claim 1, wherein the heat sink comprises one or more heat exchange features.

6. The illumination device of claim 5, wherein the heat exchange feature comprises a fin, a passage, or any combination thereof.

7. The illumination device of claim 1, wherein the radiation-transmissive enclosure comprises one or more heat exchange features.

8. The illumination device of claim 1, wherein the polymeric heat sink is characterized as being a single piece.

9. The illumination device of claim 1, wherein the polymeric heat sink comprises polybutylene terephthalate, polyamide, polyphenylene sulfide, polycarbonate, or any combination thereof.

10. The illumination device of claim 1, wherein each of the at least two light emitting diodes lie on lines that are within 5 degrees of parallel to the underlying region of the protrusion of the polymeric heat sink.

11. The illumination device of claim 1, further comprising a heat conductive material placing the second surface of the first printed circuit board and the protrusion of the heat sink into thermal communication.

12. The illumination device of claim 1, wherein the illumination device is characterized as having a beam angle of from about 290 degrees to about 330 degrees.

13. (canceled)

14. The illumination device of claim 1, wherein the heat sink has an in-plane thermal conductivity of from about 5 to about 15 W/m*K.

15. The illumination device of claim 1, wherein the heat sink has a through-plane thermal conductivity of from about 5 to about 15 W/m*K.

16. The illumination device of claim 1, wherein the illumination device satisfies the Energy Star™ LED criteria (May 13, 2011 revision of “ENERGY STAR® Program Requirements for Integral LED Lamps”; criterion 7A) for omnidirectional LED illumination devices.

17. A method, comprising:
supplying sufficient electricity to an illumination device according to claim 1 so as to effect illumination from the device.

18. An illumination device, comprising:
a single-piece polymeric heat sink; and
a first printed circuit board having at least first and second surfaces opposing one another and being separated by a thickness of the printed circuit board,
the first surface of the first printed circuit board supporting a plurality of light emitting diodes, and
the second surface of the first printed circuit board being thermally coupled to the protrusion of the polymeric heat sink.

19. The illumination device of claim 18, wherein the device is configured such that when at least some of the plurality of light emitting diodes are illuminated, the device satisfies the Energy Star™ LED criteria (May 13, 2011 revision of “ENERGY STAR® Program Requirements for Integral LED Lamps”; criterion 7A) for omnidirectional LED illumination devices.

20. An illumination device, comprising:
a single-piece polymeric heat sink having a protrusion extending therefrom;
the protrusion supporting at least two light-emitting diodes thermally coupled to the heat sink;
a radiation-transmissive enclosure configured to at least partially enclose the at least two light emitting diodes; and
a conductive path placing a light emitting diode into electrical communication with an environment exterior to the device.
